(19) United States
(12) Patent Application Publication
(10) Pub. No.: US 2009/0289814 A1
(43) Pub. Date: Nov. 26, 2009

(54) MOBILE PARKING ENFORCEMENT BOOT AND METHOD OF USING SAME

(76) Inventor: Michael Dean Jarman, Salt Lake City, UT (US)

Correspondence Address: MORRISS OBRYANT COMPAGNI, P.C., 734 EAST 200 SOUTH, SALT LAKE CITY, UT, 84102, US

(21) Appl. No.: 12/123,871

(22) Filed: May 20, 2008

(51) Int. Cl. G08G 1/01

(52) U.S. Cl. 340/933

(57) ABSTRACT

The invention relates to a highly visible parking enforcement marker that can be attached to a vehicle and locked onto the vehicle. The parking enforcement marker may be attached to a vehicle by magnetic force, suction, or a combination thereof and locked in place to prevent removal of the parking enforcement marker. The parking enforcement marker is generally constructed of a shell and an attachment structure that are configured such that when the shell can be locked to the attachment structure or the attachment structure can be locked to the vehicle. The shell then serves to prevent access to the attachment structure and prevents unauthorized removal of the parking enforcement marker.

### TECHNICAL FIELD

This invention relates to a detachable device for use in parking enforcement.

### BACKGROUND

Parking enforcement is typically carried out by issuing a parking violation ticket on a vehicle, which requires the vehicle owner to take the necessary steps, such as payment of a fine or fee to negate the ticket. In the event that the vehicle owner does not pay the required fine or fee, the vehicle may be immobilized. Typically the vehicle is immobilized by placing what is referred to as a “boot” on a wheel of the vehicle. The boot then prevents the vehicle from moving, which then ensures that the driver will pay the necessary fees in order to have the boot unlocked and removed from the vehicle.

U.S. Pat. Nos. 4,854,144 and 5,333,477 disclose mechanical boots that may be used to immobilize a vehicle. Both of these patents disclose mechanisms that grasp a tire and prevent the movement of the vehicle. While these devices are effective, they are extremely unpopular and have spawned extreme animosity toward parking enforcement officials. For example, lawsuits have been filed against parking agencies for booting cars and there is a petition in at least one town to remove the in place impoundment, booting, ordinance.

Since, applying the “boot” to a vehicle is an in-place impoundment of the vehicle, the inability to use the vehicle causes considerable frustration and anger. Further, to impound a vehicle, specific conditions must be met and the party applying the boot must have the authority to impound the vehicle.

Beyond the anger and frustration that booting a vehicle can cause, booting also requires that staff be available nearby to collect the fees/fines and remove the boot, and while the fees/fines are being paid and the boot is being removed the offending vehicle remains in the parking space. Until the fines are paid and the boot removed revenue from a valuable parking space is lost, for example, revenue may be lost from a parking spot that is occupied all weekend by the immobilized vehicle. In addition, the owner of the vehicle may be deprived of its use for a considerable period of time.

Despite these drawbacks the boot has proven to be extremely popular with parking enforcement officials due to its extreme effectiveness in motivating the vehicle operator to pay the assessed fines and fees. While the boot is effective in motivating payment, it achieves this result at a cost. It has been reported that in London as many as three parking attendants were assaulted each day by people they had ticketed. Likewise, assaults on parking enforcement officials continue to increase in major U.S. cities. The effect of the boot and increasing ticket prices has made parking enforcement a greatly maligned job that reduces the number of people in the profession and results in high turnover rates.

What is needed is a device that provides a high level of motivation to the vehicle owner to pay the fines, but does not engender as much animosity as immobilizing a vehicle.

### SUMMARY OF THE INVENTION

The invention relates to a highly visible parking enforcement marker that can be attached to a vehicle and locked on the vehicle.

In an exemplary embodiment, the invention relates to a parking enforcement marker that can be attached to a vehicle by magnetic force, suction, or a combination thereof and locked in place to prevent removal of the parking enforcement marker.

In another exemplary embodiment the parking enforcement marker is constructed of a shell and an attachment structure, which are configured such that when the attachment structure is attached to a vehicle the shell can be locked to the attachment structure and completely shield the attachment structure.

In yet another exemplary embodiment, the shell structure of the marker is constructed such that air passage over the shell produces a noise, for example, a whistling sound that increases in volume proportionally with the speed of air passage over the shell.

In yet another exemplary embodiment, the shell structure of the parking enforcement marker is constructed such that air passage over the shell produces a vibrational or shuddering force that may be transmitted to the vehicle.

In yet another exemplary embodiment, the attachment structure comprises a plurality of suction cups connected to at least one upright rigid member, wherein at least one of the upright rigid members is configured to engage the shell by way of a lockable coupling.

In another exemplary embodiment, the parking enforcement marker comprises an attachment structure having at least two separate vehicle adhesion mechanisms and a coupling mechanism and a shell comprising a shielding member and releasable fastener configured to releasably couple the shell to the attachment structure by way of the coupling mechanisms. The vehicle adhesion mechanism may comprise a suction cup, a magnet, a magnetic suction device and/or combinations thereof. Optionally, a suction/vacuum cup or a magnetic suction device may be configured with a sealable air passage that allows the vacuum in a suction cup to be released for the purpose of removing the parking enforcement marker. In another exemplary embodiment, the air passage is sealed with an air valve, for example, a two-way, normally closed valve.

In another exemplary embodiment, the invention includes a transmitter that is configured to transmit the location of the parking enforcement marker to a remote site. For example, the transmitter may be adapted to receive a signal from a global position satellite system, to process the signal into data corresponding to the geographical position of the transmitter, and to transmit the geographical position data to a receiver in a location remote from the parking enforcement marker. The transmitter may also emit a signal that allows one or more receiving stations, such as a cell phone tower, to determine the vehicles location. Transmission of the location of the parking enforcement marker allows parking enforcement personnel to track the location of the vehicle.

In another exemplary embodiment, the parking enforcement marker comprises at least two separate vehicle adhesion mechanisms selected from the group consisting of a suction cup, a magnetic suction device and combinations thereof, wherein the vehicle adhesion mechanisms are connected to a shell comprising a shielding member, wherein an air valve is configured to release a vacuum in the suction cup and thereby release the vehicle adhesion mechanisms from a vehicle.

### BRIEF DESCRIPTION OF THE DRAWINGS

FIG. 1 is a front perspective view of an embodiment of a parking enforcement marker in accordance with the principles of the present invention.

FIG. 2 is a side perspective view of an embodiment of a parking enforcement marker, illustrating a shell and attachment structure in accordance with the principles of the present invention.

FIG. 3A is a cross-sectional side view of another embodiment of a parking enforcement marker in accordance with the principles of the present invention.

FIG. 3B is a top perspective view of the top end of a coupling mechanism in accordance with the principles of the present invention.

FIG. 4 is a side perspective view of an attachment structure according to the principles of the present invention.

FIG. 5A is a side perspective view of an attachment structure according to the principles of the present invention.

FIG. 5B is a bottom view of an attachment structure according to the principles of the present invention.

FIG. 6 is a front perspective view of a vehicle adhesion system according to the principles of the present invention.

FIG. 7A is a cross-sectional side view of a vehicle adhesion system according to the principles of the present invention.

FIG. 7B is a cross-sectional side view of an alternative vehicle adhesion system according to the principles of the present invention.

FIG. 7C is a cross-sectional side view of another alternative vehicle adhesion system according to the principles of the present invention.

FIG. 7D is a top view of an alternative vehicle adhesion system according to the principles of the present invention.

FIG. 8A is a cross-sectional side view of another embodiment of a parking enforcement marker in accordance with the principles of the present invention.

FIG. 8B is a expanded cross-sectional side view of the bottom left edge of the shielding member shown in FIG. 8A.

FIG. 9 is a top view of another embodiment of an attachment structure in accordance with the principles of the present invention.

FIG. 10 is a flowchart illustrating an exemplary embodiment of a method of using the enforcement marker of the invention.

### DETAILED DESCRIPTION OF THE INVENTION

As used herein, “comprising,” “including,” “containing,” “characterized by,” and grammatical equivalents thereof are inclusive or open-ended terms that do not exclude additional, unrecited elements or method steps, but also includes the more restrictive terms “consisting of” and “consisting essentially of.”

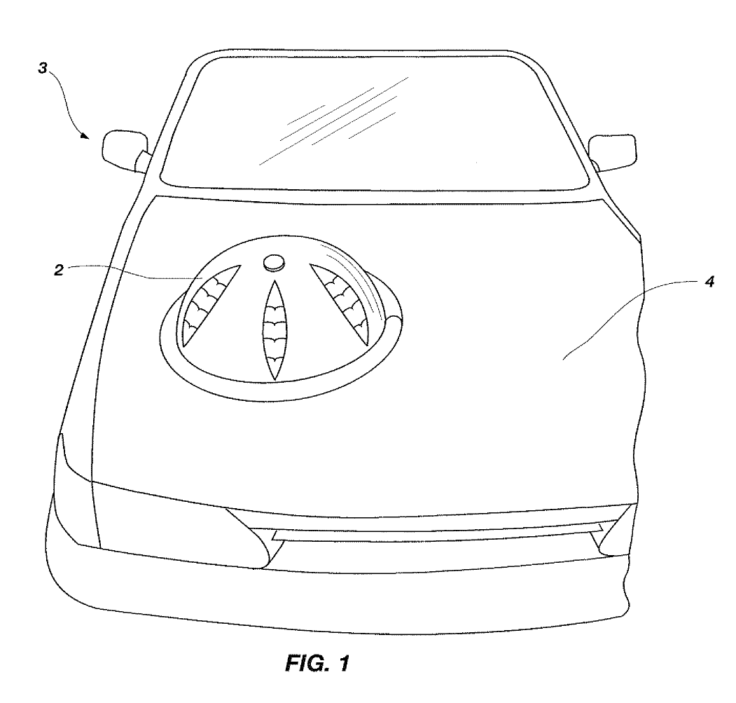

The invention relates to a highly visible parking enforcement marker 2 that can be attached to a vehicle 3 (FIG. 1), for example, to the hood 4 of the vehicle or other substantially flat surface (e.g., roof, trunk or side panel) where the parking enforcement marker 2 will serve as a constant reminder to the driver that they need to pay their parking tickets. An exemplary utility of the present invention is its ability to provide a method of parking enforcement that motivates the vehicle operator to pay the fine without stranding the vehicle operator, such as a mother with her children, during the heat of the summer or cold of winter, or damaging expensive wheel rims. Thus, the invention alleviates the abrasive, and sometimes violent, conflict of the “booter” versus the driver, allows the parking enforcement company to maintain their enforcement efforts and generate revenue instead of having to stop their parking enforcement duties to go to the vehicle and remove a “boot.” Instead, the invention provides a method that allows the driver to come to the parking enforcement company, e.g., a central office, or to a partnering business that may serve as a release point where the parking enforcement marker 2 is removed and the fines are paid.

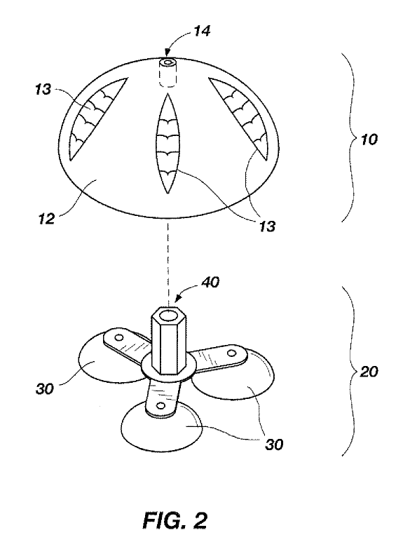

In an exemplary embodiment the parking enforcement marker 2 is constructed of a shell 10 and an attachment structure 20 (FIG. 2), which are configured such that the attachment structure 20 may be attached to a vehicle 3 and the shell 10 may be engaged to the attachment structure 20 by way of a releasable fastener 14, such that the shell 10 prevents access to the attachment structure 20.

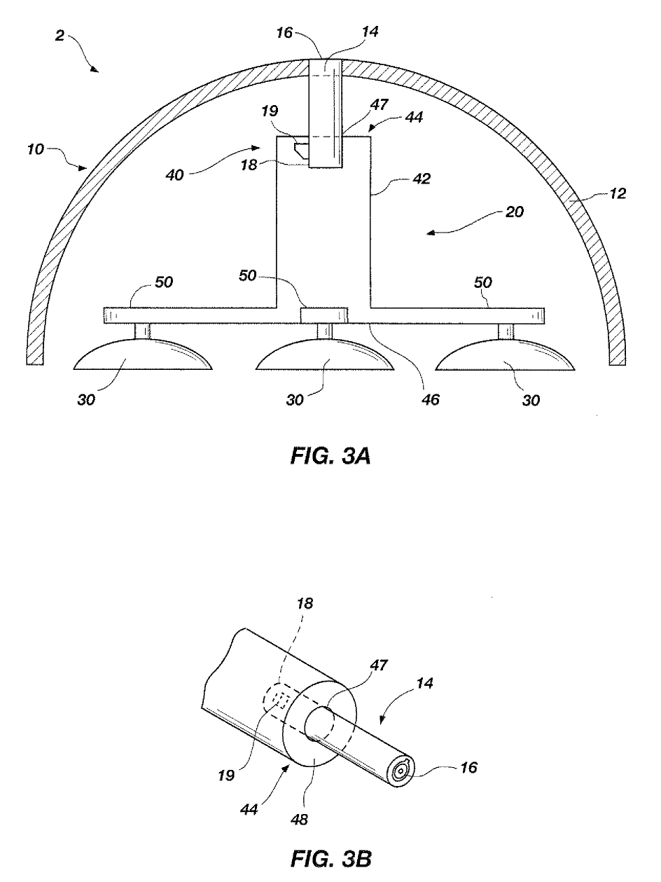

The attachment structure 20 may be constructed from any suitable material. In an exemplary embodiment, the attachment structure 20 comprises a vehicle adhesion mechanism 30 (FIGS. 2 and 3) configured to detachably adhere to a vehicle 3 and a coupling mechanism 40 configured to releasably secure the shell 10 to the attachment structure 20.

Referring to FIGS. 1, 2, 3A and 3B the parking enforcement marker 2 comprises a shell 10 and an attachment structure 20. The shell 10 comprises a shielding member 12 and a releasable fastener 14 configured to selectively attach and detach the shell 10 to a coupling mechanism 40 on the attachment structure 20. In an exemplary embodiment, the shielding member 12 may be made of a hard metal and may have a substantially hemispherical dome shape, for example, a dome shape having a diameter of approximately 17 inches, 18 inches, or 19 inches, and a height of less that about 10 inches. In other exemplary embodiments the shielding member 12 may be constructed from any suitable material, but preferably is made of a hardened material having a high degree of resistance to cutting, shattering, and/or denting. For example, the shielding member 12 may be constructed of titanium, steel, stainless steal, hard plastic, fiberglass, and/or aluminum alloys. The shielding member 12 may also be made in shapes other than a dome shape, which is an exemplary embodiment for the purpose of describing the invention. For example, the shielding member 12 and/or shell 10 may be configured to reduce wind resistant by being as flat as possible. Further, the shielding member 12 may have either a smooth outer surface or have ridges, depressions, lights, and/or noise making systems 13. In an exemplary embodiment, the shielding member 12 comprises depressions, ridges and/or other vibrational or noise generating structures 13 in the outer surface configured to produce a noise (e.g., a whistling sound) and/or vibration in response to air passage over the shielding member 12. Thus, in an exemplary embodiment, a noise and/or vibration is generated in response to driving a vehicle 4 having a parking enforcement marker 2 attached thereto, wherein the noise and/or vibration serves as a stimulus to the driver to pay the fine. In another exemplary embodiment, the shielding member 12 comprises LED lights embedded therein and optionally a speaker system (not shown) configured to produce sounds at predetermined times. As will be recognized, lights and/or a speaker system will typically require a source of power, such as a battery (not shown). In FIGS. 1-4 the releasable fastener 14 is a cylindrical lock (a barrel lock or a cylinder lock) having a key receiving end 16 and an engagement end 18, wherein a locking member 19 in the releasable fastener 14 is configured to engage the coupling mechanism 40 of the attachment structure 20 and lock the shell 10 over the attachment structure 20. In this exemplary embodiment, the key receiving end 16 is securely mounted in the shielding member 12 such that the key receiving end 16 is substantially flush or slightly recessed relative to the shielding member 12, for example, the releasable fastener 14 may be attached to the shielding member 12 by welding, coupled by way of threading, made as a unitary construction, or any other means known in the art. In the exemplary embodiment shown in FIGS. 1-4, the coupling mechanism 40 comprises one or more upright rigid member 42 having a top end 44 and a bottom end 46. The top end 44 of the upright rigid members 42 has an aperture 47 sized to receive the engagement end 18 of the releasable fastener 14 and a flange 48 configured to retain the releasable fastener 14 when a locking member 19 is extended therefrom. Thus, the releasable fastener 14 comprises a lock securely attached to the shielding member 12 that allows the shell 10 to be locked to the attachment structure 20, thereby preventing access to the vehicle adhesion mechanism 30 when the parking enforcement marker 2 is attached to a vehicle (see FIG. 1).

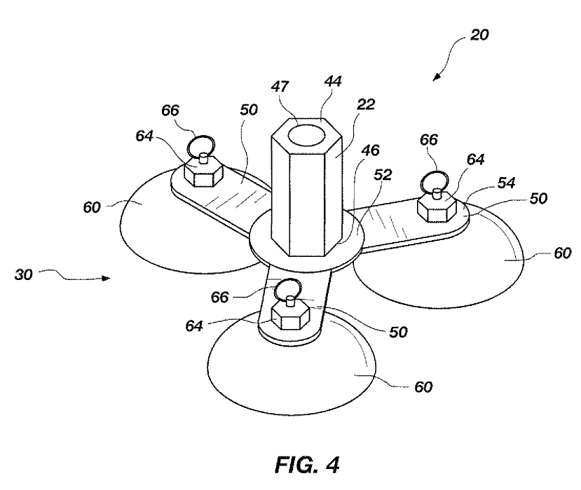

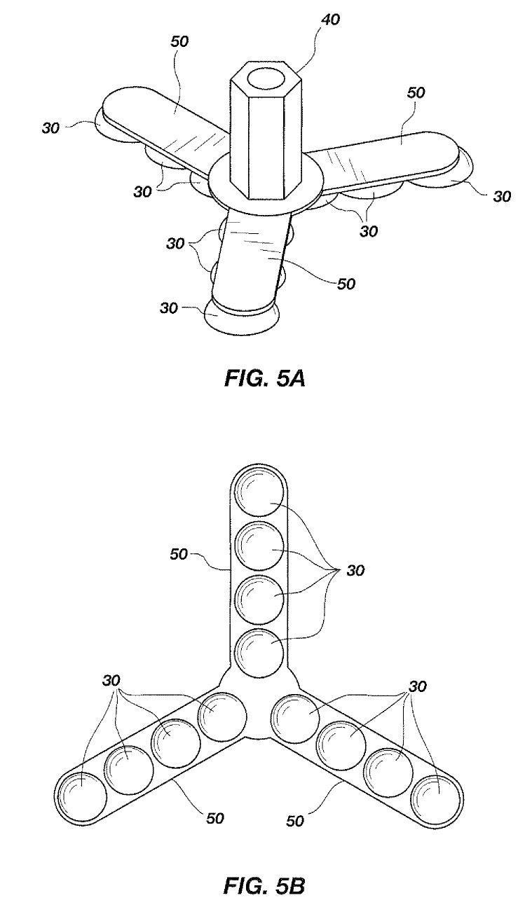

In FIG. 4 the attachment structure 20 comprises three radial arms 50, which rigidly interconnect a plurality of vehicle adhesion mechanisms 30 to the coupling mechanism 40. In an exemplary embodiment, the upright rigid members 42 are connected to a substantially disc shaped plate 52 from which the three radial arms 50 extend. In this configuration, the upright rigid members 42 are disposed at a substantially right angle relative to the radial arms 50. The vehicle adhesion mechanisms 30 are connected to the distal end 54 of each radial arm 50. While a single vehicle adhesion mechanism 30 is illustrated at the distal end of each radial arm 50, other configurations are contemplated. For example, there may be any number or configuration of arms, e.g., 1 arm, 2 arms, 3 arms, 4 arms, 5 arms, 6 arms, etc. Likewise, each arm may have one or more vehicle adhesion mechanisms 30 attached thereto, for example, multiple smaller vehicle adhesion mechanisms 30 may be utilized per arm (see, e.g., FIGS. 5A and 5B).

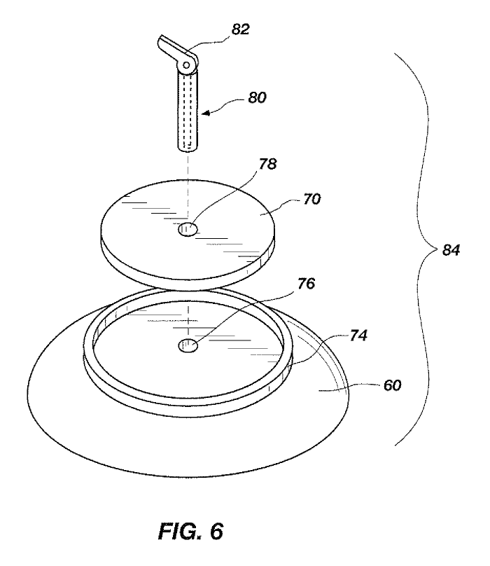

In an exemplary embodiment, the vehicle adhesion mechanism 30 may comprise a suction cup (which includes a vacuum cup) 60 (FIGS. 4 and 6). Suction cups 60 are commercially available from All-Vac Industries and may comprise a 5 inch silicon vacuum cup (part number A1867-RSC) and/or a trigger valve assembly (an air valve 64; part number 6532-T). The vehicle adhesion mechanism 30 and/or suction cup 60 may have any desirable shape, for example, a substantially circular or oval shape. The vehicle adhesion mechanism 30 may also comprise an air valve 64 configured to open and close an air channel 66 (FIG. 6) and release a vacuum created by the suction cup 60 (see, e.g., U.S. Pat. Nos. 6,186,415; 5,651,520; 5,511,752; and 5,381,990). As shown in FIG. 4, the air valve 64 may be a relatively simple poppet valve having a pull tab 66 connected to a central stem and sealing mechanism of a two-way, normally closed valve, such that pulling on the pull tab 66 opens the air valve 64 and releases the suction cup 60. Alternatively, the vehicle adhesion mechanism 30 may comprise a suction cup 60 and other systems known in the art, such as a lever (not shown) connected to a peripheral edge of the suction cup 60 such that movement of the lever exerts a releasing force on the peripheral edge of the suction cup 60 to release the vacuum therein (e g., see U.S. Pat. No. 5,454,540), or a lever that exerts an adhesion force on the center of the suction cup (e.g., PCT Publication WO 2006/138335).

Referring to the exemplary embodiment shown in FIG. 6, the vehicle adhesion mechanism 30 may also comprise a combination of a suction cup 60 and a magnet 70. In this exemplary embodiment, the magnet 70 is configured to be received and held in a central position above the suction cup 60 by a magnet retention flange 74 in the suction cup 60. The suction cup 60 has a first air passage way 76 that is configured to align with a second air passage way 78 in the magnet 70. An air valve 80 is configured to open and close the air passage way 76 and/or 78. The air valve 80 may have a mechanism 82 that allows the air valve 80 to be opened while the vehicle adhesion mechanism 30 is mounted onto or removed from a vehicle 3 and closed when retention of the parking enforcement marker 2 to the vehicle 3 is desired. For an example of a magnetic suction device see U.S. Pat. No. 5,641,105 and U.S. Pat. No. 5,460,310.

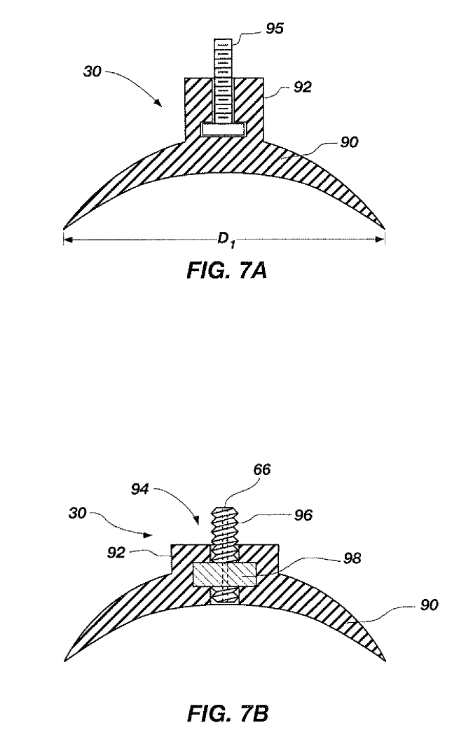

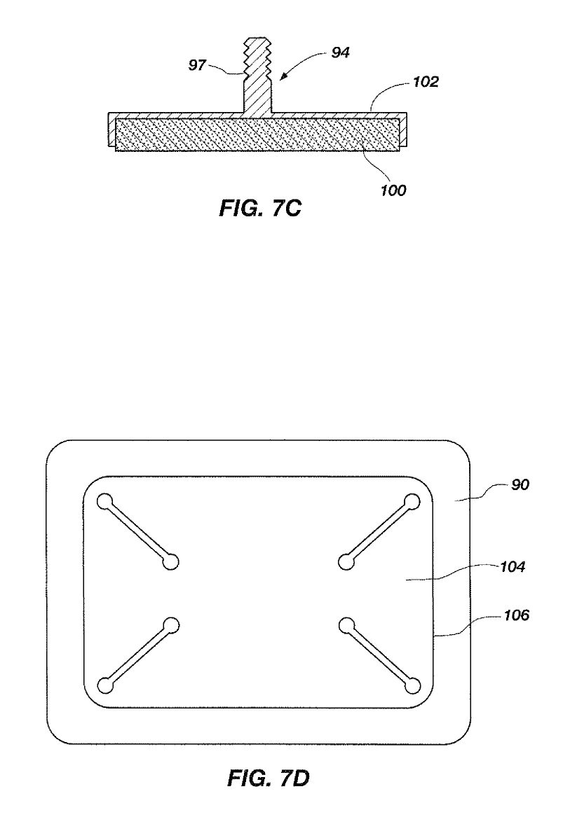

While the vehicle attachment mechanism 30 illustrated in FIG. 6 is a magnetic suction device 84, the vehicle attachment mechanism 30 may also comprise a just a suction cup 90 (FIG. 7A), having a stem 92, and connection means 94, such as a threaded rod, bolt, or screw 95. As shown n FIG. 7B, the vehicle attachment mechanism 30 may also comprise a suction cup 60, having a stem 92, and a connection means 94, such as a hollow threaded rod 96 that is retained in the stem 92 by a threaded nut 98. In this embodiment, the air passage 66 may travel through the suction cup 60 by way of the hollow rod 96 and be sealable by way of an air valve (not shown). As shown in FIG. 7C, the vehicle attachment mechanism 30 may also comprise a magnet 100 and an optional metal cup 102 having a connection means 94, such as a threaded connector 97, that is configured to, directly or indirectly, connect the vehicle attachment mechanism 30 to the coupling mechanism 40. For example, the stein 96 may fit through a hole (not shown) in the radial arm 50 and be attached by a nut (not shown) that connects to a threaded portion of the stem 96. Likewise, the stem 96 may be welded to the radial arm 50 or the stem 96 and radial arm 50 may be an integral piece of metal. The magnet 100 may be rigid or deformable. For example, as shown in FIG. 7D, a deformable magnet 104 may be configured such that the suction cup 90 extends from the deformable magnet's 104 peripheral edge, wherein the suction cup 90 and deformable magnet 104 form a magnetic suction device 84 (e.g, see U.S. Pat. Nos. 5,641,105 and 5,460,310).

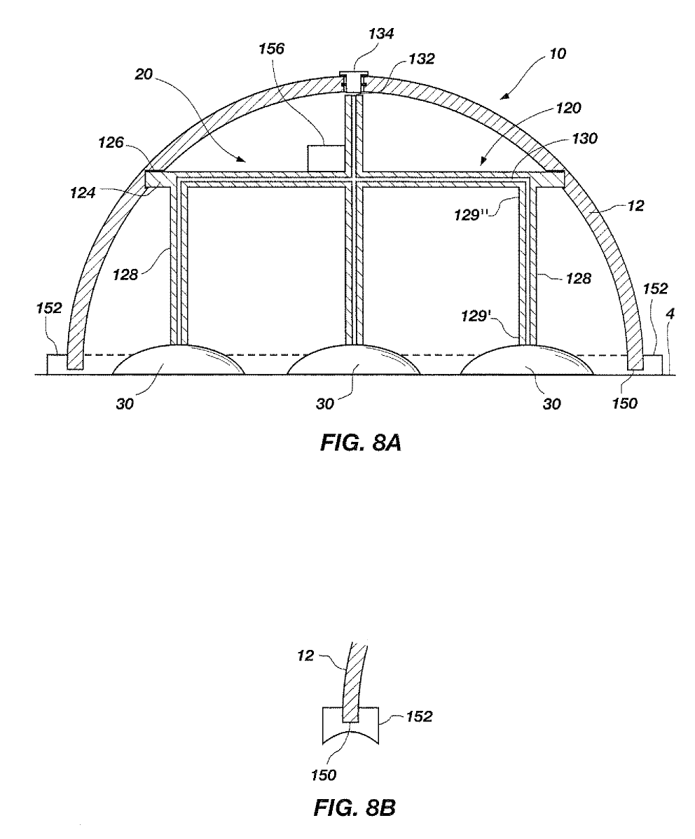

Referring to FIG. 8, the attachment structure 20 and shell 10 may comprise a single unit, wherein the attachment structure 20 is non-separately joined to the shell. For example, the attachment structure 20 may comprise one or more upper members 120 that are configured to attach to the shell 10 such that the shielding member 12 is free to rotate around the attachment structure 20. For example, the one or more upper members 120 may be of sufficient length that each end 124 of the upper member 120 engages in a groove or channel 126 within the shell 10, such that when the parking enforcement marker 2 is attached to a vehicle 3 a rotational twisting force applied to the shell merely results in rotation of the shell 10 without transmitting sufficient force to the vehicle adhesion mechanism 30 to cause it to break free of the vehicle.

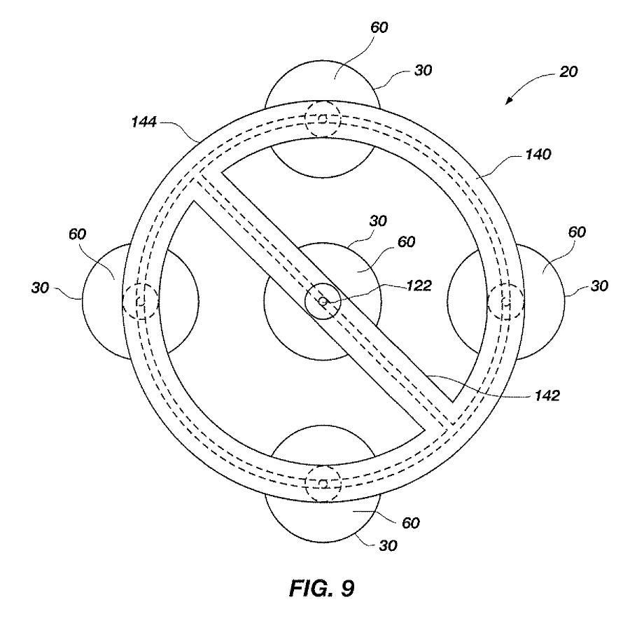

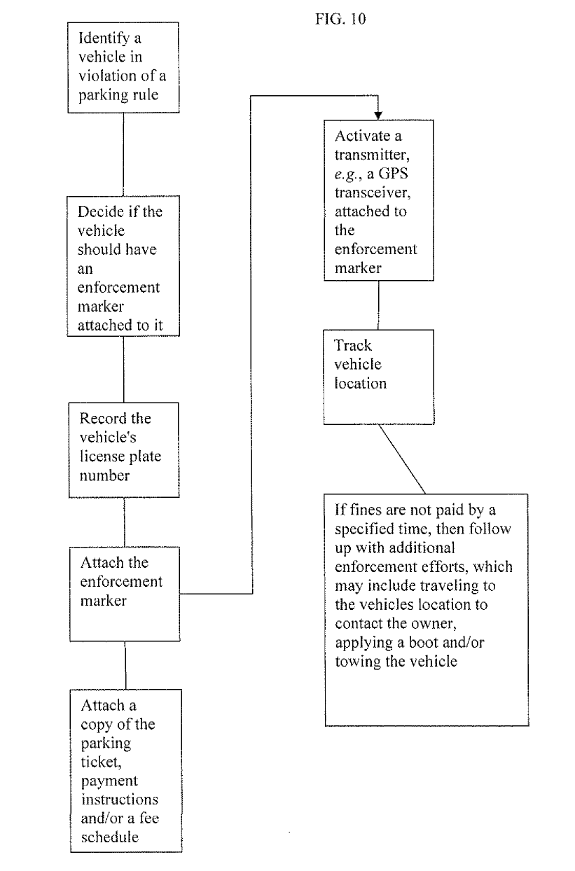

A plurality of posts 128 having at least one vehicle adhesion mechanism 30 attached to a distal end 129′ are attached at the proximal end 129″ to the one or more upper members 120. The one or more upper members 120 and the plurality of posts 128 may have an interconnected air passage 130 sealably coupled to the vehicle adhesion mechanisms 30, for example, by way of an air valve 132. In this exemplary embodiment, the shell 10 comprises a shielding member 12 and a locking plug 134, wherein the locking plug prevents or grants access to the air valve 132. Alternatively, the locking plug 134 may be directly coupled to the air passage 130, wherein locking the plug 134 seals the air passage 130 and unlocking the plug 134 opens the air passage 130. The attachment structure 20 of FIG. 8 may be a single upper member 120, having two or more posts 128 (e.g., three posts 128), or may he a plurality of upper members 120 attached to a plurality of posts 128, for example, two upper members 120 may form an “X” shape or a cross. In addition, the one or more upper members 120 may comprise a circular member 140 (FIG. 9) traversed by a cross member 142 configured such that an outer edge 144 of the circular member 140 engages a groove or channel 126 in the shell 10.

In yet another exemplary embodiment, the shell 10 has a releasable fastener 14 (e.g., FIG. 3A) for lockably coupling the shell 10 to the attachment structure 20.

In yet another exemplary embodiment, the shielding member 12 is configured such that air passage over the shell 10 produces a noise, for example, a whistling sound that increases in volume proportionally with the speed of air passage over the shell 10.

In yet another exemplary embodiment, the shell 10 structure of the parking enforcement marker 2 is constructed such that air passage over the shell 10 produces a vibrational or shuddering force that is transmitted to the vehicle 3 (not shown, see, e.g., FIG. 2).

As shown in FIG. 8, in yet another exemplary embodiment, the shell 10 structure comprises a vehicle contacting edge 150 that may be covered with a padding material 152, such as rubber or foam rubber. In another exemplary embodiment, the padding material 152 is a silicone rubber configured to provide a suction force along the vehicle contacting edge of the shielding member 12 (FIG. 8B).

In yet another exemplary embodiment, the attachment structure 20 comprises a plurality of vehicle adhesion mechanisms 30 connected to at least one upright rigid member 42, wherein at least one of the upright rigid members 42 is configured to engage the shell 10 by way of a releasable fastener 14 (a lock), such that the plurality of vehicle adhesion mechanisms 30 are shielded by a solid smooth shell 10 (e.g. FIGS. 1, 2, 3A and 3B).

Referring again to FIG. 3A, in yet another exemplary embodiment, the parking enforcement marker 2 comprises a transmitter 156 that enables the parking enforcement marker 2 and, hence, the vehicle 3 that it is attached to, to be tracked from a remote location. Preferably the transmitter 156, which may also be a transceiver, has sufficient power to allow the transmission to pass through concrete ceilings, walls and other barriers, such as an underground garage. In another exemplary embodiment, the transmitter 156 comprises a global positioning system (GPS) that allows the transmitter 156 to transmit the location of the vehicle 3 to a remote location. For example, see U.S. Pat. Nos. 4,177,466; 6,748,226; 6,298,306; 5,890,068; and 5,703,598. The transmitter 156 may be attached to any component of the parking enforcement marker 2, such as the shell 10, shielding member 12, and/or attachment structure 20.

In another exemplary embodiment, the invention provides a method of parking enforcement that comprises attaching a parking enforcement marker 2 to a vehicle 3, tracking the position of the parking enforcement marker 2 and vehicle 3 using a transmitter such as a GPS transceiver, recording the license plate, and assessing an additional fine if the parking enforcement marker is not returned with payment of back fines by a predetermined time. In another exemplary embodiment, fines may be increased periodically until such time as the parking enforcement marker 2 is brought to the appropriate parking enforcement personnel for removal (return) or an additional fine is assessed. For example, the sooner the fine is paid and the device removed, the less money the owner will have to pay.

In another exemplary embodiment, the parking enforcement marker 2 may sound an audible alarm if a vehicle 3 owner or another unauthorized party attempts to tamper with the parking enforcement marker 2.

In another exemplary embodiment, the parking enforcement marker 2 may comprise one, two, three, four, five or six vehicle adhesion mechanisms 30, wherein the vehicle adhesion mechanisms 30 may be a suction cup, a magnet, a magnetic suction device and/or combinations thereof.

All references, including publications, patents, and patent applications, cited herein are hereby incorporated by reference to the same extent as if each reference were individually and specifically indicated to be incorporated by reference and were set forth in its entirety herein.

While this invention has been described in certain embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A parking enforcement marker, comprising:
an attachment structure having at least one vehicle adhesion mechanism and a coupling mechanism; and
a shell comprising a shielding member and releasable fastener configured to releasably couple the shell to the attachment structure by way of the coupling mechanism.

2. The parking enforcement marker of claim 1, comprising at least two separate vehicle adhesion mechanisms.

3. The parking enforcement marker of claim 1, wherein the vehicle adhesion mechanism comprises a suction cup.

4. The parking enforcement marker of claim 1, wherein the vehicle adhesion mechanism comprises a magnet.

5. The parking enforcement marker of claim 1, wherein the vehicle adhesion mechanism comprises a magnetic suction device.

6. The parking enforcement marker of claim 5, wherein the magnetic suction device comprises a sealable air passage.

7. The parking enforcement marker of claim 1, wherein the shielding member has a substantially hemispherical shape.

8. The parking enforcement marker of claim 7, wherein the releasable fastener comprises a cylindrical lock.

9. The parking enforcement marker of claim 3, wherein the suction cup further comprises a sealable air passage.

10. The parking enforcement marker of claim 9, wherein the air passage is sealed with an air valve.

11. The parking enforcement marker of claim 10, wherein the air valve is a two-way, normally closed valve.

12. The parking enforcement marker of claim 1, wherein the shell comprises one or more ridges or depressions configured to produce a noise in response to air passage over the shell.

13. The parking enforcement marker of claim 1, wherein the shell comprises one or more ridges or depressions configured to produce a vibration in response to air passage over the shell.

14. The parking enforcement marker of claim 1, further comprising a transmitter configured to transmit the location of the parking enforcement marker to a remote site.

15. The parking enforcement marker of claim 14, wherein the transmitter is adapted to receive a signal from a global position satellite, to process the signal into data corresponding to the geographical position of the transmitter, and to transmit the geographical position data to a receiver in a location remote from the parking enforcement marker.

16. The parking enforcement marker of claim 14, wherein the transmitter emits a signal that allows one or more receiving stations to determine a vehicle location.

17. A parking enforcement marker, comprising:
at least one vehicle adhesion mechanism selected from the group consisting of a suction cup, a magnetic suction device and combinations thereof, wherein the vehicle adhesion mechanism is connected to a shell comprising a shielding member; and
an air valve configured to releasably couple the vehicle adhesion mechanisms to a vehicle.

18. The parking enforcement marker of claim 17, wherein the vehicle adhesion mechanism comprises a suction cup or a magnetic suction device having a sealable air passage configured to release a vacuum in the suction cup or the magnetic suction cup when the air passage is in an open position.

19. The parking enforcement marker of claim 17, further comprising a transmitter configured to transmit the location of the parking enforcement marker to a remote site.

20. The parking enforcement marker of claim 19, wherein the transmitter is adapted to receive a signal from a global position satellite, to process the signal into data corresponding to the geographical position of the transmitter, and to transmit the geographical position data to a receiver in a location remote from the parking enforcement marker.

21. The parking enforcement marker of claim 19, wherein the transmitter emits a signal that allows one or more receiving stations to determine a vehicle location.

22. The parking enforcement marker of claim 19, wherein the shell comprises one or more ridges or depressions configured to produce a noise in response to air passage over the shell.

23. A method of increasing payment of parking fines, the method comprising:
attaching a parking enforcement marker to a vehicle, wherein the parking enforcement marker comprises an attachment structure having at least one vehicle adhesion mechanism and a coupling mechanism, and a shell comprising a shielding member and releasable fastener configured to releasably couple the shell to the attachment structure by way of the coupling mechanisms;
recording the license plate number of the vehicle; and
providing information regarding a fine schedule and payment options.
